(19) United States
(12) Patent Application Publication
(10) Pub. No.: US 2017/0019823 A1
(43) Pub. Date: Jan. 19, 2017

(54) MOBILE COMMUNICATION SYSTEM, COMMUNICATION APPARATUS AND COMMUNICATION CONTROL METHOD

(71) Applicant: NEC Corporation, Tokyo (JP)

(72) Inventor: Makoto FUJINAMI, Tokyo (JP)

(73) Assignee: NEC Corporation, Tokyo (JP)

(21) Appl. No.: 15/300,740

(22) PCT Filed: Mar. 19, 2015
(86) PCT No.: PCT/JP2015/001550

§ 371 Date: Sep. 29, 2016

(30) Foreign Application Priority Data
Mar. 31, 2014 (JP) 2014-071253

(51) Int. Cl. H04W 36/12; H04W 36/32; H04W 36/00

(52) U.S. Cl. CPC H04W 36/12; H04W 36/0022; H04W 36/32; H04W 88/182

(57) ABSTRACT

A mobile communication system, a communication apparatus and a communication control method are provided that can maintain the continuity of a service mobile terminals are using while reducing the loads on a server and a network. A communication apparatus (A, B) including virtual machines (100) accommodating sessions of mobile terminals and a virtual machine control means (101) for controlling the virtual machines, and a terminal location synchronization detection function (104) of determining whether or not changes in location of at least two mobile terminals (102) are in sync are provided, wherein if there are at least two terminals whose changes in location are in sync, respective sessions of these at least two mobile terminals are accommodated by a single virtual machine in the communication apparatus.

### TECHNICAL FIELD

The present invention is based upon and claims the benefit of priority from Japanese Patent Application No. 2014-071253, filed on Mar. 31, 2014, the disclosure of which is incorporated herein in its entirety by reference.

The present invention relates to a mobile communication system including mobile terminals and, more particularly, to a communication apparatus and a communication control method for continuing a communication of a terminal.

### BACKGROUND ART

Mobile communication systems for providing mobility to a terminal via a mobility anchor include, for example, 3GPP (The 3rd Generation Partnership Project), 3GPP2 (The 3rd Generation Partnership Project2) and WiMAX (Worldwide Interoperability for Microwave Access). Moreover, protocols for implementing mobility include GTP (GPRS (General Packet Radio Service) Tunneling Protocol), MIPv6 (Mobility IPv6), PMIPv6 (Proxy MIPv6), MIPv4 (Mobility IPv4), PMIPv4 (Proxy MIPv4) and the like. GTP, MIPv6 and PMIPv6 are adopted as protocols for implementing mobility (mobility protocols) in 3GPP, whereas MIPv4, MIPv6, PMIPv4 and PMIPv6 are adopted in WiMAX. Any of the mobile communication systems and any of the mobility protocols have commonality in their basic operation of forwarding traffic addressed to a mobile terminal to a point of connection to this mobile terminal.

In such mobile communication systems, a system has been proposed in which a proxy delivery server is disposed between a core network and an external network in order to suppress a delay of traffic and to maintain the continuity of a service that a mobile terminal is using, even if mobility anchor relocation takes place (see PTL 1). This system will be described briefly with reference to FIG. 1.

Referring to FIG. 1, a case will be considered where a plurality of proxy delivery servers 60a and 60b are disposed at the boundary between an external network and a core network, and where GW relocation from an access network gateway (GW) 20a to another access network GW 20b and anchor relocation from a mobility anchor 10a to another mobility anchor 10b take place due to a move of a terminal 40. When a relocation request is made from the mobility anchor 10b, the proxy delivery server 60b makes a context request to the proxy delivery server 60a, which is relaying the delivery of a content to the terminal 40, and acquires context information related to the relaying of the content.

The context information includes, for example, content location information, session information and the like. The content location information indicates a location in the content to be delivered up to which the content has been delivered to the mobile terminal 40, and is expressed by elapsed time, the number of bytes, the number of key frames in a compressed image stream, or the like from the head of the content. The session information is information required to allow a session with the mobile terminal 40 to continue. In case of the HTTP/TCP protocol, the session information includes, for example, HTTP header information indicating the non-completion of transmission to the mobile terminal 40, a source address, a destination address, TCP source and destination port numbers, a sequential number, an acknowledgement number, flag information to be set in the flag field of the TCP header, a window size, and transmission buffer information.

When receiving such context information, the proxy delivery server 60b uses this context information to reproduce, between the terminal 40 and itself, the state of the content delivery session between the proxy delivery server 60a and the terminal 40, and uses the reproduced session to forward the subsequent part of the content from the service providing server 50 to the terminal 40.

The provision of proxy delivery servers as described above makes it possible to reduce the delay time of traffic and to achieve efficient use of network resources even if there is a long distance in terms of topology between the mobility anchor 10a and the access network GW 20b.

### CITATION LIST

### Patent Literature

### [PTL 1]

### Japanese Patent Application Unexamined Publication No. 2012-182690

### SUMMARY

### Technical Problem

However, to transfer context information between proxy delivery servers, a source proxy delivery server needs to extract the above-described content location information, session information and the like to generate the context information. Information such as session information to be extracted from the OS (Operating System) of a proxy delivery server, in particular, cannot be easily acquired because, in general, an interface enabling such extraction from the OS is not defined. More generally, it is not easy to move between communication apparatuses (e.g., the proxy delivery servers disclosed in PTL 1) that manage the state of communication with a terminal while maintaining the state of communication.

Moreover, in a case where many terminals are located under the coverage of a radio base station and a proxy delivery server is deployed in the course of a communication path between this radio base station and a service providing server, the problem arises that, if these terminals geographically move at the same time and the management thereof is relocated to another proxy delivery server, this puts a squeeze on the physical resource capacity of the proxy deliver server and the transfer of context information also causes a squeeze on the communication bandwidth between the proxy delivery servers.

Accordingly, an object of the present invention is to provide a mobile communication system, a communication apparatus and a communication control method that can maintain the continuity of a service that mobile terminals are using while reducing the loads on a server and a network.

### Solution to Problem

A mobile communication system according to the present invention is a mobile communication system including a plurality of mobile terminals, characterized by comprising: a communication apparatus including virtual machines that accommodate sessions of mobile terminals and a virtual machine control means that controls the virtual machines; and a terminal location synchronization determination means that determines whether or not at least two mobile terminals synchronously changes in location, wherein if at least two terminals are synchronously changing in location, respective sessions of these at least two mobile terminals are accommodated by a single virtual machine in the communication apparatus.

A communication apparatus according to the present invention is a communication apparatus in a mobile communication system including a plurality of mobile terminals, characterized by comprising: virtual machines that accommodate sessions of mobile terminals; a virtual machine control means that controls the virtual machines; and a terminal location synchronization determination means that determines whether or not at least two mobile terminals synchronously changes in location, wherein if at least two terminals are synchronously changing in location, respective sessions of these at least two mobile terminals are accommodated by a single virtual machine.

A communication control method according to the present invention is a communication control method in a mobile communication system including a plurality of mobile terminals, wherein the mobile communication system further includes a communication apparatus that includes virtual machines that accommodate sessions of mobile terminals and a virtual machine control means that controls the virtual machines, characterized by comprising: by a terminal-location sync detection section, determining whether or not at least two mobile terminals synchronously changes in location; and by the communication apparatus, if at least two terminals synchronously change in location, accommodating respective sessions of these at least two mobile terminals in a single virtual machine.

### Advantageous Effects of Invention

According to the present invention, it is possible to maintain the continuity of a service that mobile terminals are using while reducing the loads on a server and a network.

### BRIEF DESCRIPTION OF DRAWINGS

FIG. 1 is a schematic system architecture diagram for describing a mobile communication system as a background technology.

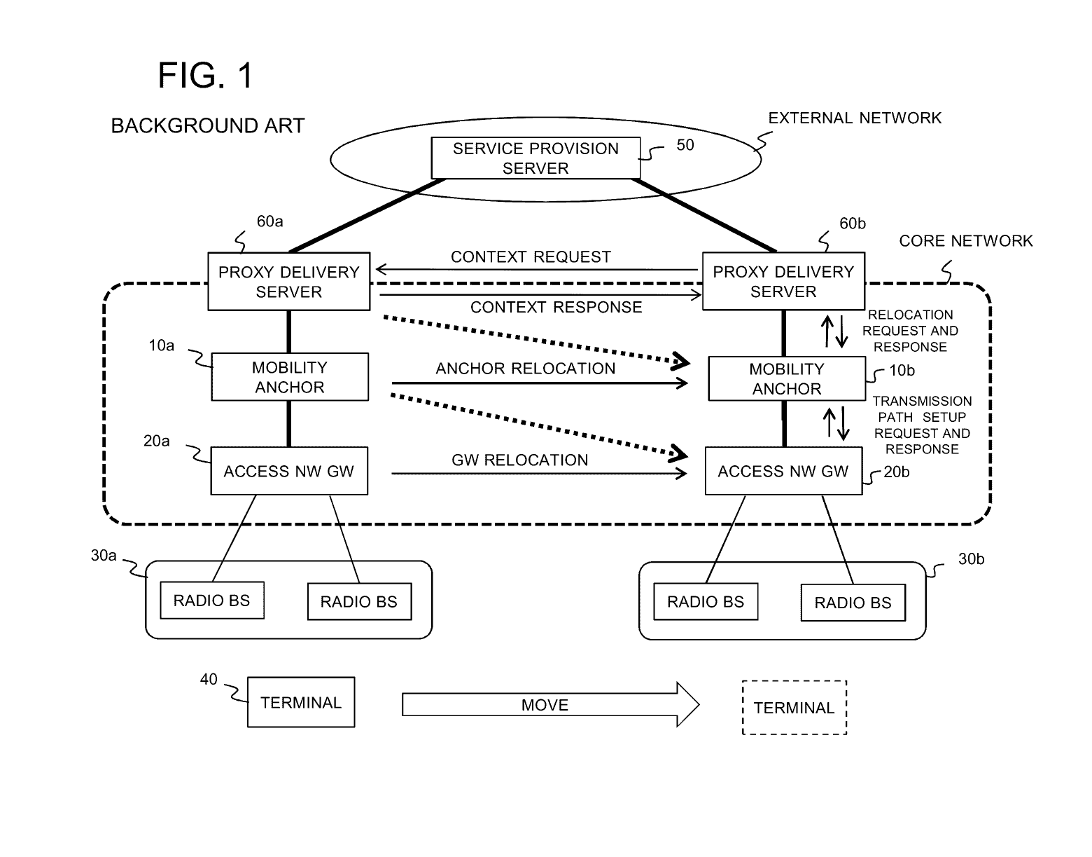

FIG. 2 is a schematic system architecture diagram for describing VM migration employed in an exemplary embodiment of the present invention.

FIG. 3 is a block diagram showing the architecture of a communication system according to the exemplary embodiment of the present invention.

FIG. 4 is a block diagram showing the functional configuration of a proxy service providing server in the present exemplary embodiment.

FIG. 5 is a schematic diagram showing an example of a terminal session-VM correspondence table in the present exemplary embodiment.

FIG. 6 is a flowchart showing operation of the proxy service providing server shown in FIG. 4.

FIG. 7 is a block diagram showing the functional configuration of a terminal-location sync detection section in the present exemplary embodiment.

FIG. 8 is a schematic diagram showing an example of a terminal location management table in the present exemplary embodiment.

FIG. 9 is a flowchart showing operation of the terminal-location sync detection section shown in FIG. 7.

FIG. 10 is a schematic network diagram showing an example of processing of a new session of a terminal in a system according to an example of the present invention.

FIG. 11 is a sequence diagram showing operation in the communication system according to the present example.

### DETAILED DESCRIPTION

### Outline of an Exemplary Embodiment of the Present Invention

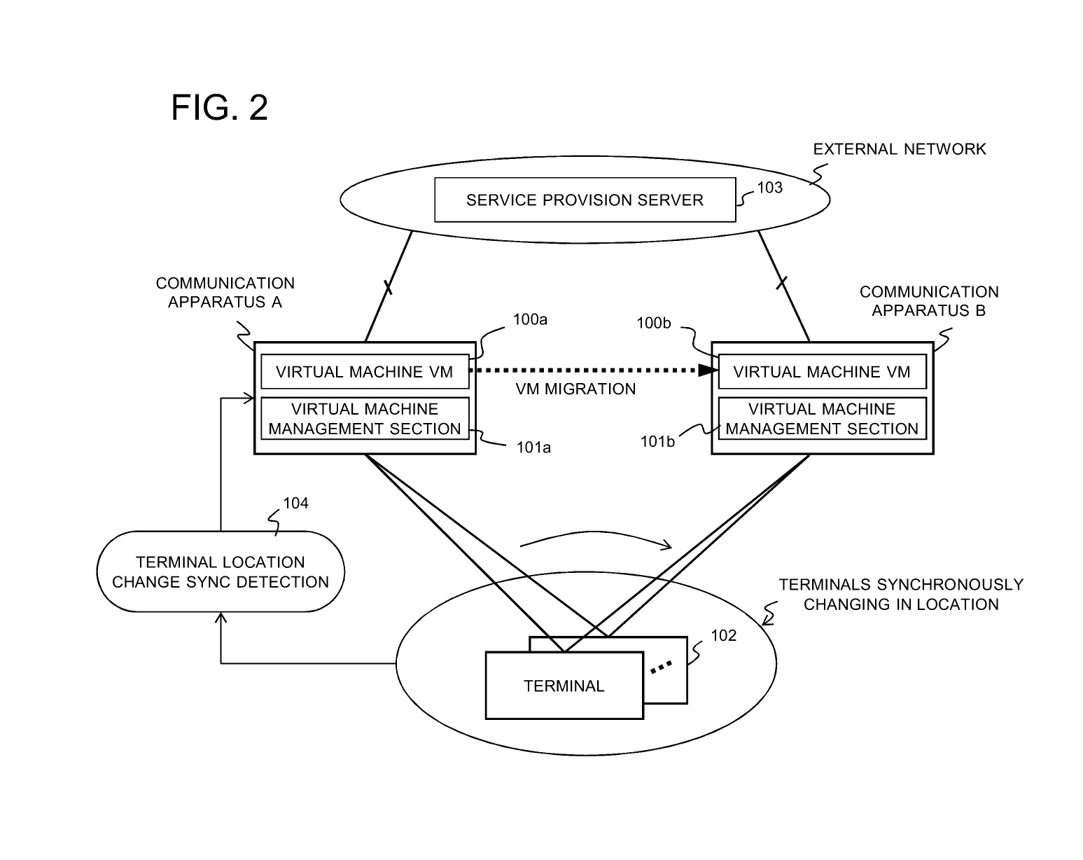

According to an exemplary embodiment of the present invention, in a system in which a virtual machine (VM) that manages the state of communication with a terminal is run on a communication apparatus and such management can be relocated onto another communication apparatus by VM migration, if changes in location of a plurality of terminals are in synchronization with each other, control is performed such that sessions of these terminals are run on the same VM. Thus, even if accommodating sessions of a plurality of terminals, the physical resource capacity required of a communication apparatus can be reduced, and the number of VMs migrated between communication apparatuses is decreased, and accordingly the load on the network is also lessened. Hereinafter, a more detailed description will be given with reference to FIG. 2.

As illustrated in FIG. 2, it is assumed that a virtual machine 100, which manages the state of communication with a terminal, and a virtual machine management section 101 operate on communication apparatuses A and B, and that virtual machine migration is performed by the virtual machine management section 101. More specifically, the virtual machine 100a and virtual machine management section 101a operate on the communication apparatus A before migration, and the virtual machine 100b and virtual machine management section 101b operate on the communication apparatus B after migration. Hereinafter, it will be assumed that an arbitrary virtual machine is indicated when only a reference number is affixed thereto like “virtual machine 100”, and that a pre-migration virtual machine and a post-migration virtual machine are indicated, respectively, when letters a and b are also affixed thereto like “virtual machine 100a” and “virtual machine 100b”. The letters will be used similarly to represent radio base stations and other apparatuses.

The system according to the present exemplary embodiment includes a function 104 of detecting a plurality of terminals that are changing in location in the same manner. Terminals changing in location in the same manner can appear, for example, when they move along a road in the same direction, when they ride on the same conveyance, or the like. If there are such a plurality of terminals 102 changing in location in the same manner, respective management functions for the individual terminals are accommodated in the same virtual machine 100a on the communication apparatus A. Then, when virtual machine migration between communication apparatuses takes place due to moves of the plurality of terminals 102, the management functions for the plurality of terminals 102 can be relocated to the other communication apparatus B by migration of only this one virtual machine 100a.

In this manner, the relocation-destination communication apparatus B can reproduce the state of a session with each of the plurality of terminals 102 by using session information before migration. Accordingly, the operations for extracting required information from OS and generating and transferring context information as described above are unnecessary, making is possible to easily relocate the communication apparatus while maintaining the continuity of a service provided by the communication apparatus itself or a service provided from an external network.

Hereinafter, a system will be described as an example in which a mobility anchor providing mobility to terminals and an access network gateway are packet gateways, a service providing server 103 on an external network provides a service, and the communication apparatuses A and B function as proxy service delivery servers. The service providing server 103 is a server providing a service to mobile terminals and corresponds to, for example, a WEB server, a video/music distribution server or the like. Moreover, it is assumed that the communication apparatus A/B can provide a service of relaying and forwarding a connection request from a terminal to the service providing server 103 on the external network and a service of relaying and forwarding a service provided by the service providing server to the terminal, or a service of terminating such a service once and then transmitting the service to the terminal, and/or the communication apparatus itself can provide a communication service (e.g., an address translation service such as NAT (Network Address Translation)) to a terminal. However, the present invention is not limited to these services.

### 1. SYSTEM ARCHITECTURE

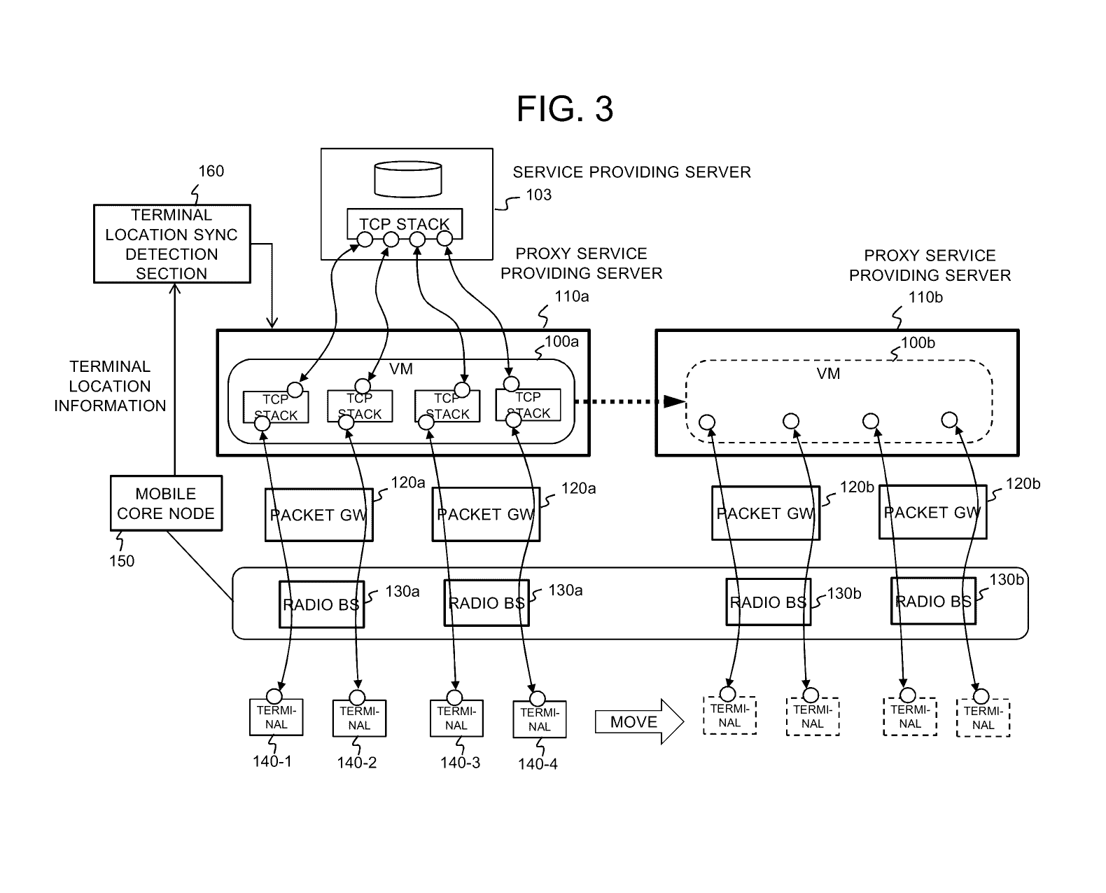

Referring to FIG. 3, the mobile communication system according to the exemplary embodiment of the present invention includes the service providing server 103 on an external network, a core network, which includes proxy service providing servers 110 and packet gateways 120, radio base stations 130, mobile terminals 140, a mobile core node 150, which detects the location of each mobile terminal, and a terminal-location sync detection section 160 which detects location synchronization of terminals.

The proxy service providing server 110 is a physical machine provided between the service providing server 103 and packet gateways 120 and has a function of hiding relocation from the mobile terminals 140 and securing the continuity of a service even if a mobility anchor implemented on the packet gateway 120 is relocated. Further, the proxy service providing server 110 runs one or a plurality of virtual machines 100 accommodating the mobile terminals 140 and provides the proxy service providing server function itself through the virtual machine 100. Note that the proxy service providing server 110 is also provided with a virtual machine management section for performing VM migration and a management section for running sessions of a plurality of terminals synchronously changing in location on the same VM (not shown in FIG. 3). Details thereof will be described later.

The packet gateway 120 is present within the network of an operator that mainly provides mobile communication services, and routes data sent by the mobile terminal 140 via the radio base station 130 to the external network. In FIG. 3, a mobility anchor function and an access network GW function are included in the packet gateway 120.

The radio base station 130 sends and receives traffic to/from the mobile terminal 140 by using any of various radio access technologies adopted by individual mobile communication systems. In a case of 3GPP, traffic of the mobile terminal 140 is transferred to/from the access network GW by means of tunneling according to GTP (GPRS Tunneling Protocol).

The mobile terminal 140 is a terminal performing mobile communication, such as a portable terminal, smartphone or note PC. In a case where MIPv6 or MIPv4 is supported as a mobility protocol, the mobile terminal 140 is equipped with processing functions for implementing mobile communication, such as location registration as mentioned above.

The mobile core node 150 has a function of detecting the location of each mobile terminal 140 via the radio base station 130. For example, a mobility management node (MME) in the core network can be used for implementing the function.

The terminal-location sync detection section 160 has functions of detecting the synchronization of changes in location of terminals based on each terminal's location information acquired from the mobile core node 150 and of notifying information about the synchronized terminals to the proxy service providing server 110. The terminal-location sync detection section 160 may be provided within the proxy service providing server 110, or may be provided separately.

As an example, when four mobile terminals 140-1 to 140-4 are changing in location in the same manner, a proxy service providing server 110a acquires these mobile terminals' location sync information from the terminal-location sync detection section 160 and performs control such that sessions of these mobile terminals will be run on a single virtual machine 100a. Since the sessions of the mobile terminals 140-1 to 140-4 are managed by the virtual machine 100a in this manner, it is only necessary to migrate the single virtual machine 100a when the management of the sessions of the mobile terminals is relocated to another proxy service providing server 110b due to moves of the mobile terminals 140-1 to 140-4.

### 2. PROXY SERVICE PROVIDING SERVER

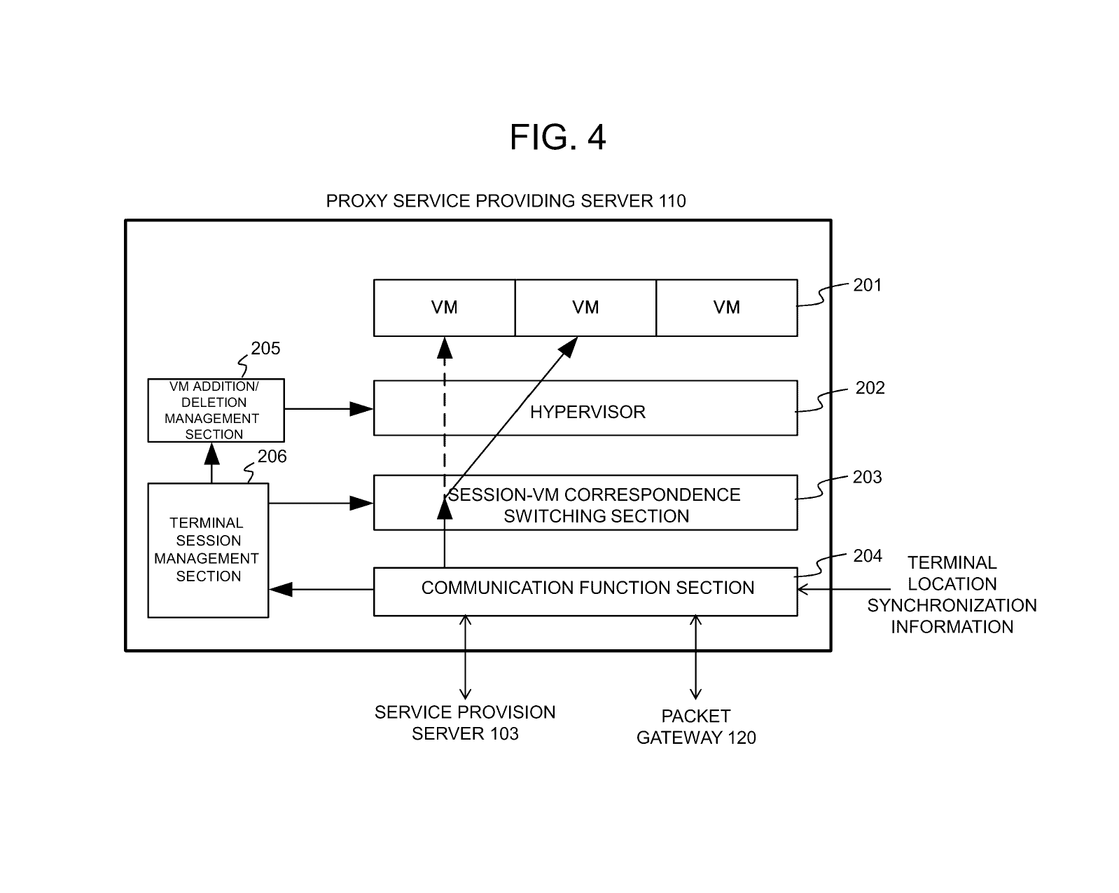

The proxy service providing server 110 according to the first exemplary embodiment of the present invention acquires information related to terminals whose changes in location are in sync (terminal location synchronization information) from the terminal-location sync detection section 160 and performs control such that the sessions of the terminals that are making identical geographical changes will be accommodated by the same VM, as described above. Hereinafter, the configuration and operation of the proxy service providing server 110 will be described with reference to FIG. 4.

### 2.1) Configuration

Referring to FIG. 4, the proxy service providing server 110 includes virtual machines 201, a hypervisor 202 for generating and running a virtual machine, a session-VM correspondence switching section 203 for switching correspondences between a session and a virtual machine, and a communication function section 204 for performing communication with the service providing server 103, packet gateway 120 and terminal-location sync detection section 160, and further includes functions implemented by a VM addition/deletion management section 205 and a terminal session management section 206.

Each virtual machine VM terminates traffic between a mobile terminal and the service providing server 103 and, even if the mobility anchor is relocated, hides such relocation from the mobile terminal and secures the continuity of a service.

The terminal session management section 206 acquires information about which terminals' changes in location are in sync (terminal location synchronization information) from the terminal-location sync detection section 160 periodically, or when synchronization is detected or when synchronization is lost, and manages the terminal location synchronization information using a session-VM correspondence table and also controls the session-VM correspondence switching section 203. For example, when a request for connection to the proxy service providing server 103 arises from a mobile terminal, and if a virtual machine VM is operating that collectively manages terminals changing in location in the same manner as this mobile terminal, then this connection request is switched to this virtual machine VM.

The session-VM correspondence switching section 203 performs switching operation in accordance with a signal for controlling which terminal's request should arrive at which VM. A target mobile terminal of this control can be identified by referring to the source IP address, the source MAC address and the like included in the packet header of a connection request.

Moreover, the terminal session management section 206 requests the VM addition/deletion management section 205 to add or delete a virtual machine. The VM addition/deletion management section 205, when receiving a VM addition/deletion request, adds/deletes an instance of the proxy service providing server to/from the hypervisor 202. Note that a function similar to the VM addition/deletion management section 205 may be executed by the terminal session management section 206.

Examples of application of the proxy service providing server 110 include, but are not limited to, a proxy delivery server (web proxy server), and any server will do as long as it terminates an end point of the provision of a service.

### 2.2) Terminal Session-VM Correspondence Table

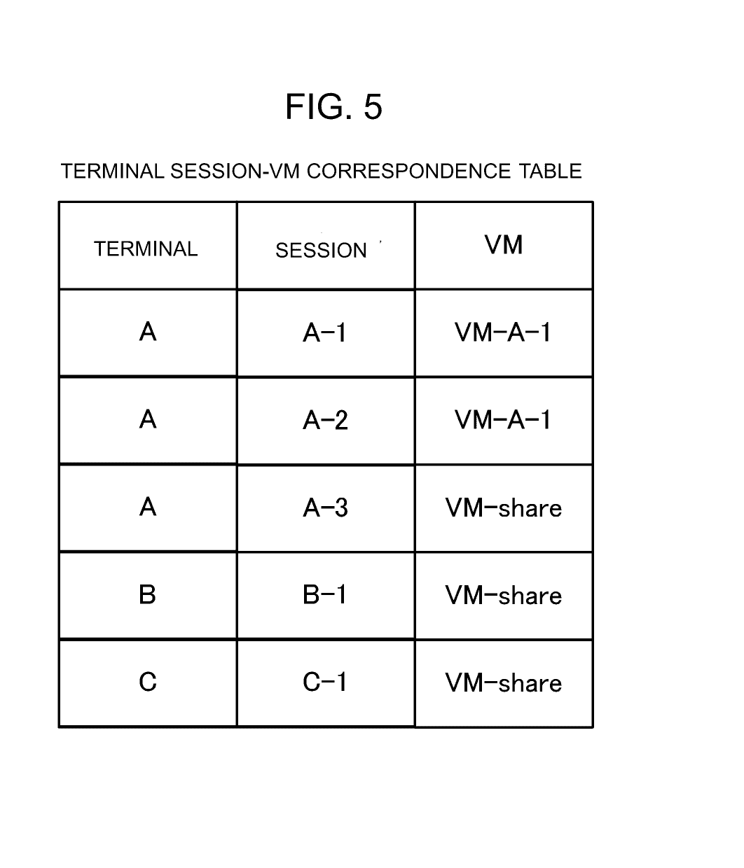

As illustrated in FIG. 5, the session-VM correspondence table in the terminal session management section 206 manages a correspondence between a mobile terminal, a session thereof and a virtual machine managing this session. This example shows a case where the respective locations of terminals B and C are changing in sync, and changes in location of a terminal A, which has been moving solely, become in sync with the changes in location of the terminals B and C. Since the locations of the terminals B and C are in sync, their respective sessions B-1 and C-1 are managed by a common virtual machine VM-share.

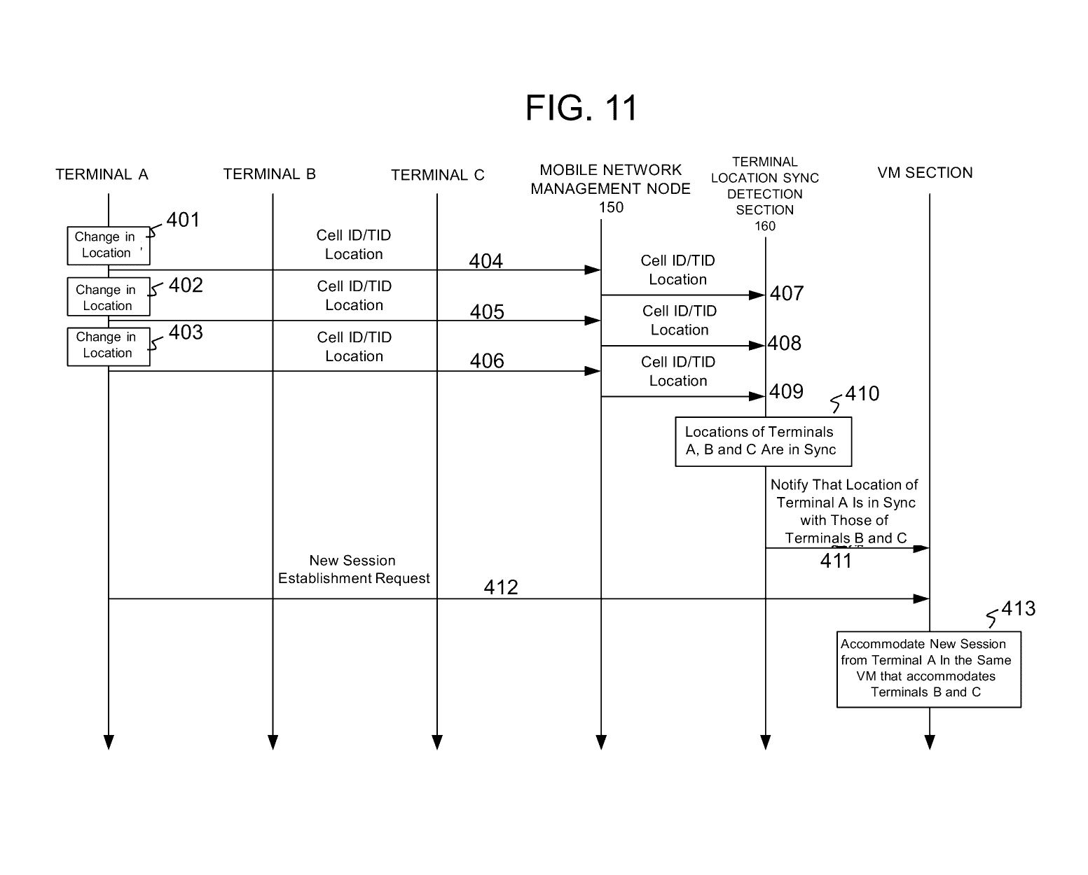

Sessions A-1 and A-2 of the terminal A are managed by a single virtual machine VM-A-1 while the terminal A is moving solely. However, when changes in location of the terminal A are synchronized with those of the terminals B and C, a session A-3 of the terminal A is managed by the same virtual machine VM-share that manages the terminals B and C. A specific example will be described later (see FIG. 11).

### 2.3) Operation

Next, operation of the proxy service providing server 110 will be described. First, it is assumed that the proxy service providing server 110 has already accommodated sessions of a plurality of terminals whose changes in location are in sync, like the terminals B and C shown in FIG. 5, and that a virtual machine VM-share managing them is operating. A description will be given of operation in a case where, in this state, a new communication request arises from a terminal A and changes in location of this terminal A are in sync with those of the other terminals.

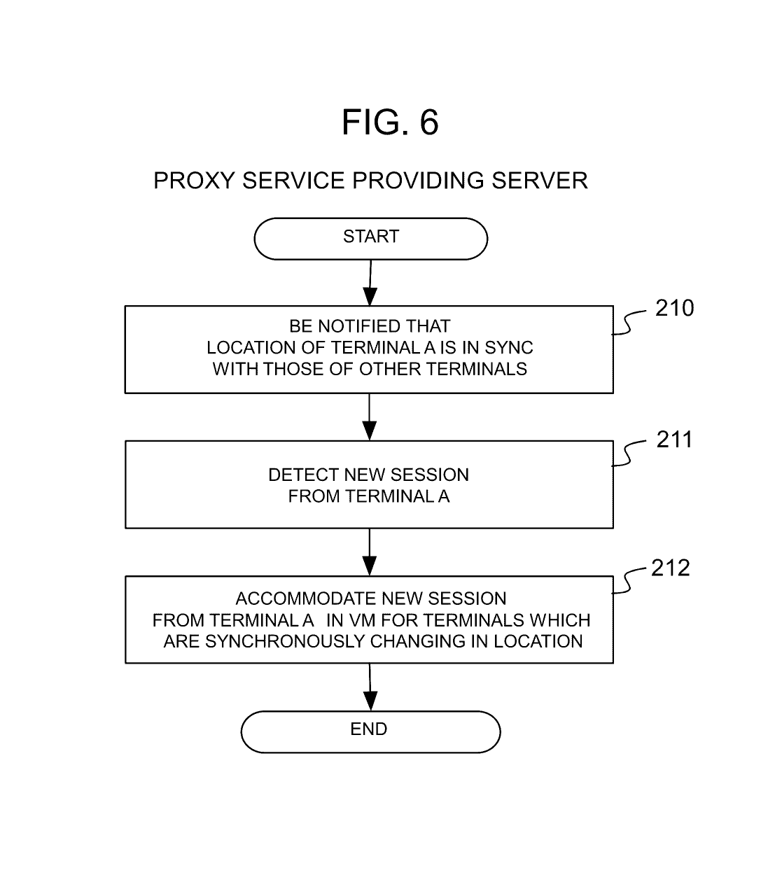

Referring to FIG. 6, the proxy service providing server 110 is notified by the terminal session management section 160 that the location of the terminal A is changed in sync with those of the other terminals (Operation 210). Upon this notification, the terminal session management section 206 sets the session-VM correspondence switching section 203 to direct a new communication request from the terminal A, when it arrives, to the virtual machine VM-share.

Subsequently, when detecting a new session, or a request for communication with the service providing server 103, from the terminal A (Operation 211), the session-VM correspondence switching section 203 performs control to direct the new session from this terminal A to the existing VM-share (Operation 212).

Thus, sessions from the plurality of terminals which are synchronously changing in location can be managed by the single virtual machine VM-share.

### 3. TERMINAL-LOCATION SYNC DETECTION SECTION

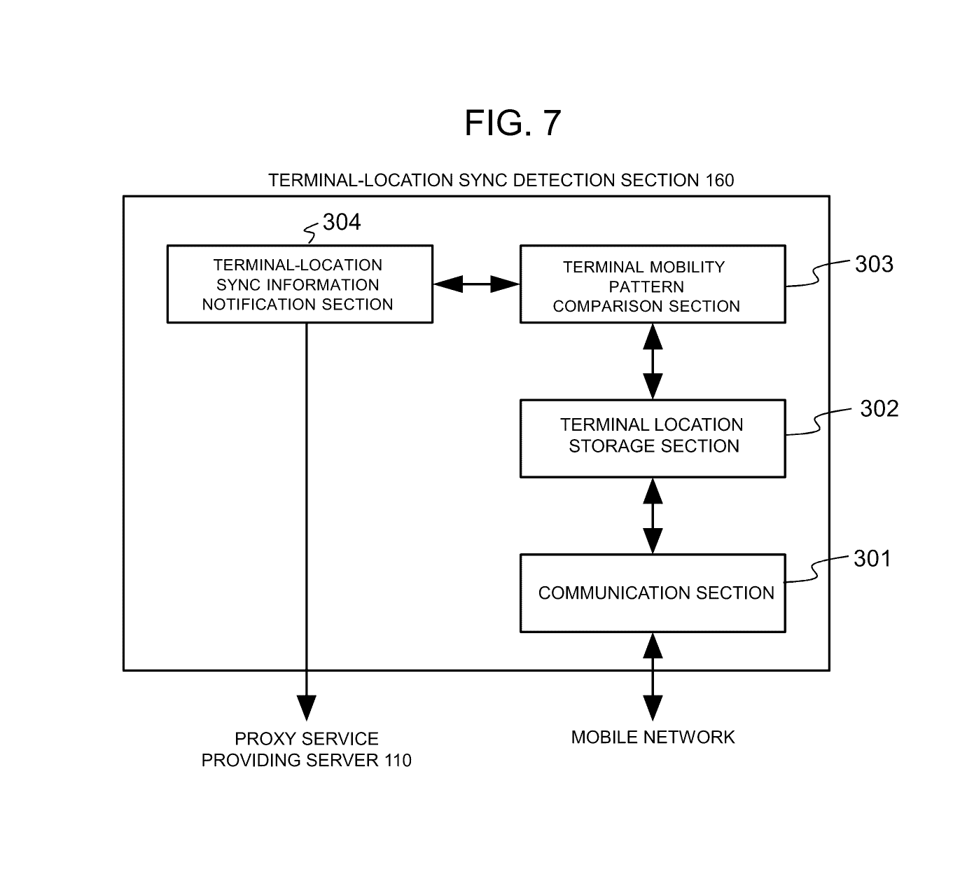

The terminal-location sync detection section 160 generates, from location information on a plurality of terminals, terminal location synchronization information about terminals whose changes in location are in sync, and notifies it to the proxy service providing server 110 as described above. Hereinafter, a detailed description will be given with reference to FIGS. 7 to 9.

### 3.1) Configuration

Referring to FIG. 7, the terminal-location sync detection section 160 includes a communication section 301, a terminal location storage section 302, a terminal mobility pattern comparison section 303 and a terminal location synchronization information notification section 304. The communication section 301 performs communication with the node 150 that manages terminals' locations, such as a MME in the mobile network. The terminal-location sync detection section 160 acquires information about terminals' locations from the node 150. As an acquisition method, the node 150 may be polled, or when a change in location is observed, the node 150 may notify such an event. Note that the terminal-location sync detection section 160 may be a physically independent node, or may be provided within another physical node such as a proxy service providing server.

The terminal location storage section 302 stores a terminal location management table including the history of each terminal's location. Here, it is assumed that employed is a table format storing location information on each terminal at each acquisition time in time sequence. As location information on a terminal, the followings can be used: latitude and longitude information, which can be acquired from a GPS (Global Positioning System), a tracking area ID in a mobile network, a routing area ID, a base station/cell ID or the like. In the present exemplary embodiment, it is assumed that a cell ID is used for location information on a terminal.

The terminal mobility pattern comparison section 303 refers to the information on the histories of terminals' locations stored in the terminal location storage section 302 and compares changes in location of each terminal with one another, thereby detecting a group of terminals presenting changes in location in the same manner, which will be described next. Information on each terminal in this terminal group is output to the terminal-location sync information notification section 304. The terminal-location sync information notification section 304 generates terminal location synchronization information from the information on the terminals synchronously changing in location, and notifies it to the proxy service providing server 110.

### 3.2) Terminal Location Management Table

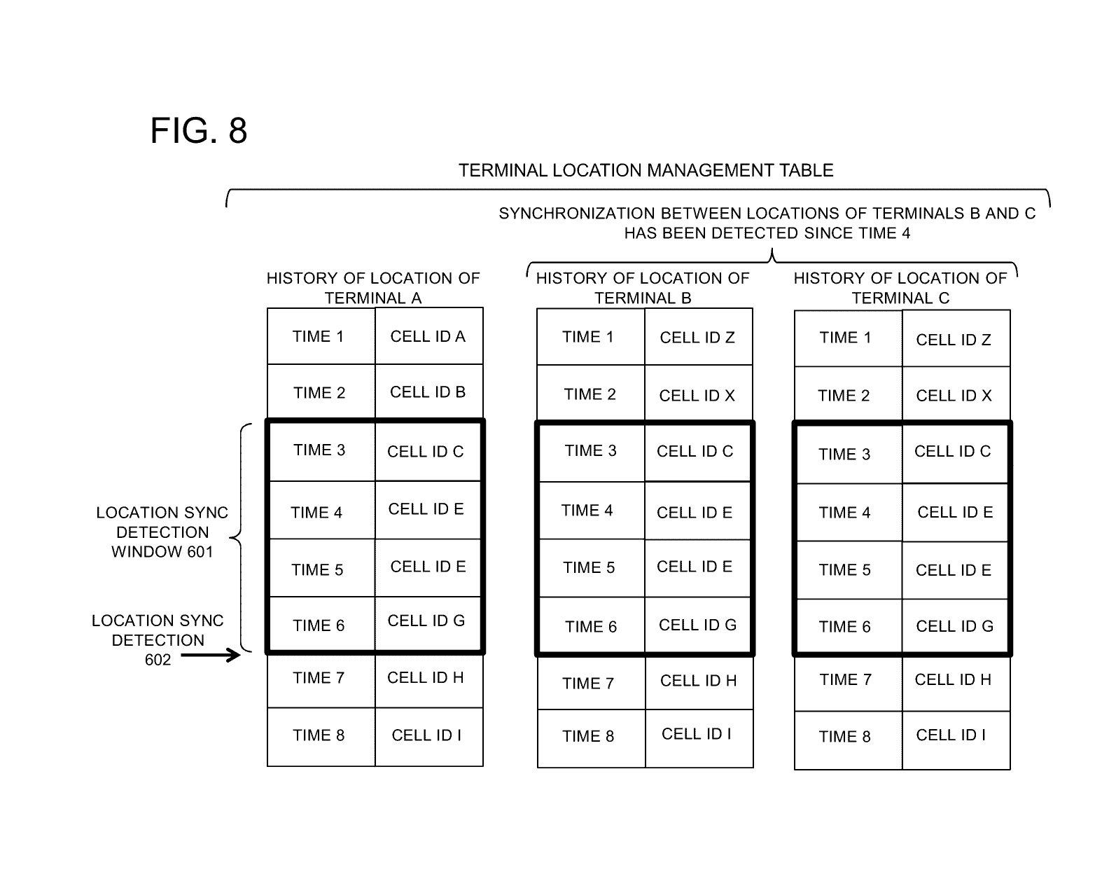

Referring to FIG. 8, a location history table is prepared for each terminal, and location information (a cell ID) is recorded therein at each time. To detect synchronization of changes over time in location information of terminals, target terminals of synchronization detection should be recorded and compared on the same attribute basis and in the same units of information. Moreover, it is preferable that all of the location information to be acquired from the terminals should be acquired at the same time, which, however, is not necessarily perfectly the same, and it is sufficient if it can be determined that location information and times of change in location information are in sync at a certain probability or higher.

The example shown in FIG. 8 shows that changes in location of the terminals A, B and C are all identical within a location synchronization detection window 601 having a predetermined time interval (here, a duration of four instants). That is, the location synchronization detection window 601 is a time range for checking whether or not changes in location information of the terminals are in sync, from the current time (here, Time 6) back to a certain past time. It will be defined that synchronization of location is detected (location synchronization detection 602) when the same changes in location are detected within the location synchronization detection window 601 as described above. However, changes in location information of terminals are not necessarily perfectly the same within the location synchronization detection window 601, depending on location information to be used, and it is sufficient if it can be estimated that, for example, the same changes in location of terminals are indicated at a certain value of probability or higher.

In the example shown in FIG. 8, changes in location information of the terminals B and C are all in sync from Time 1 to Time 8, and synchronization of their locations is already detected. However, it is not until as long time as the location synchronization detection window has passed to become Time 4 that it can be determined that their locations are in sync. That is, at Time 4, the terminal-location sync detection section 160 notifies the proxy service providing server 110 of terminal location synchronization information which indicates that changes in location information of the terminals B and C are in sync. The proxy service providing server 110 having received this notification makes the sessions of the terminals B and C to be accommodated by a common VM.

### 3.3) Operation

First, it is assumed that two or more terminals are connected to a mobile network and intend to perform, or are performing, communication.

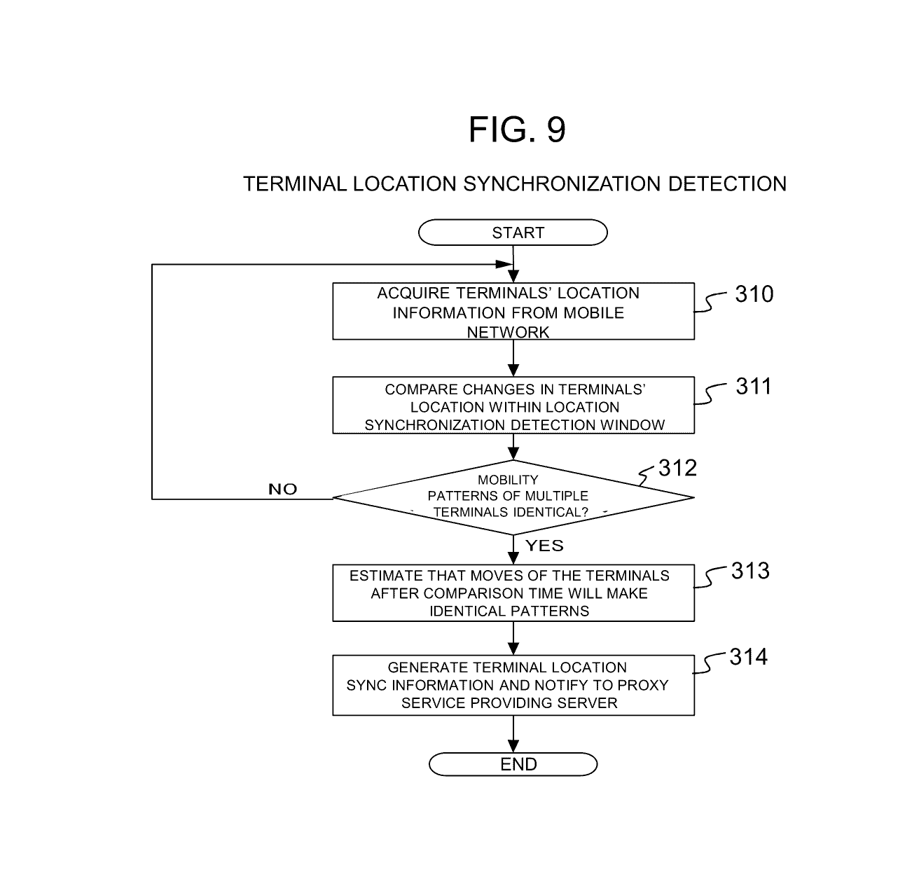

Referring to FIG. 9, the terminal-location sync detection section 160 acquires location information on a plurality of terminals from the node 150 in the mobile network via the communication section 301 and stores the location information in the terminal location information storage section 302 (Operation 310).

Subsequently, the terminal mobility pattern comparison section 303 refers to the location information on each terminal from the terminal location information storage section 302, compares changes in location information of the terminals (mobility patterns) within the current location synchronization detection window (Operation 311), and determines whether or not the mobility patterns of a plurality of terminals are identical (Operation 312). If they are not identical (Operation 312; NO), the terminal mobility pattern comparison section 303 returns to Operation 310 and repeats Operations 311 and 312 by using a location synchronization detection window at the point of time when location information at a subsequent time is stored.

Mobility patterns are compared by using a location synchronization detection window each time location information is stored in this manner. When the mobility patterns of a plurality of terminals are identical (Operation 312; YES), the terminal mobility pattern comparison section 303 estimates that changes in location information of the plurality of terminals will be in sync for a certain period of time in future, based on the fact that they have been in sync for a past certain period of time (Operation 313). This estimation of synchronization is not necessarily based on the identical patterns of changes in location as illustrated in FIG. 8, but a case is also included where, for example, terminals are handed over in a certain fixed pattern between base stations arranged along a railway, road or the like. In such a case, when location information in a preset area is detected, it can be estimated that location information will be in sync in future.

When synchronization of location is detected as described above, the terminal-location sync information notification section 304 generates terminal location synchronization information from information on the terminals of which synchronization of location is detected, and notifies it to the proxy service providing server 110 (Operation 314).

### 4. EXAMPLE

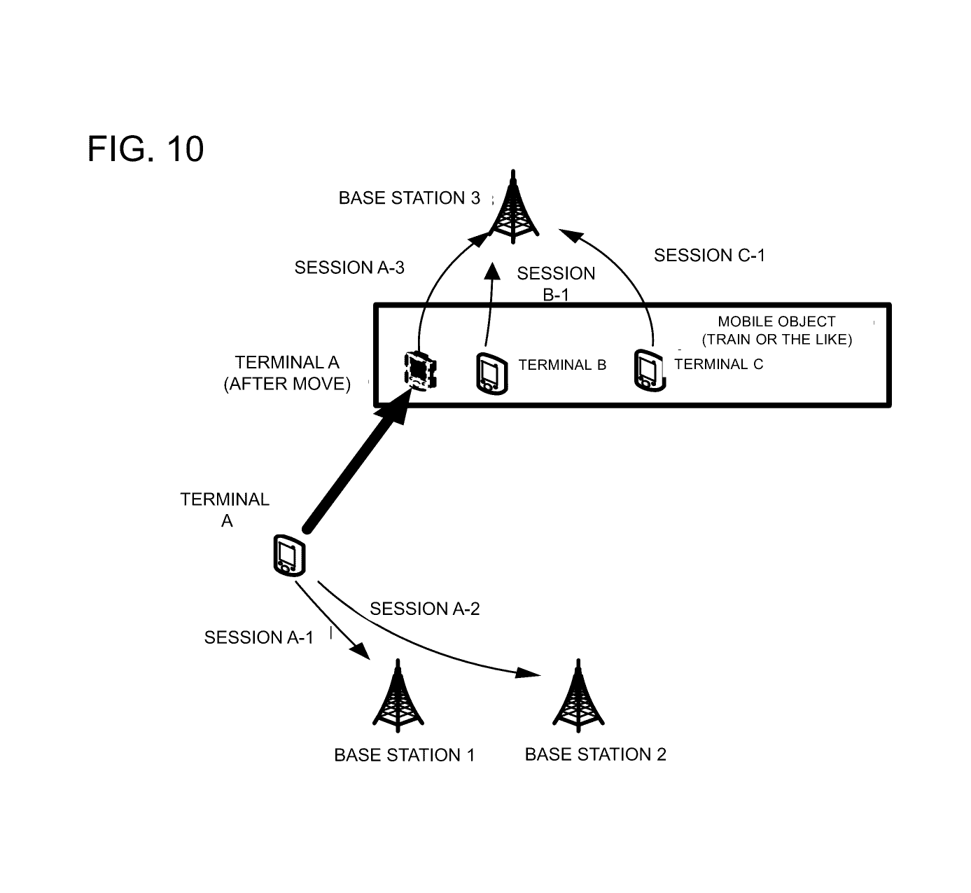

A processing flow in a mobile communication system according to an example of the present invention will be described with reference to FIGS. 10 and 11. However, the base station 130, packet gateway 120 and service providing server 103 are omitted.

Referring to FIG. 10, it is assumed that terminals B and C are riding on a mobile object such as a train and are moving, and that their respective sessions B-1 and C-1 are accommodated by a common virtual machine VM-share in the proxy service providing server 110 as described above (see the terminal session-VM correspondence table in FIG. 5). Moreover, it is assumed that while a terminal A is moving solely, the terminal A has two sessions A-1 and A-2, which are accommodated by a virtual machine VM-A-1 in the proxy service providing server 110 (see the terminal session-VM correspondence table in FIG. 5). Subsequently, when the terminal A rides on the same mobile object as the terminals B and C, the management of a session A-3 of the terminal A is accommodated by the common VM-share that accommodates the terminals B and C, because it is determined that changes in location of the terminal A are in sync with the terminals B and C (see the terminal session-VM correspondence table in FIG. 5). The above-described operation in the entire system is shown in a sequence diagram of FIG. 11.

Referring to FIG. 11, first, it is assumed that the terminal-location sync detection section 160 has already detected that the locations of terminals B and C are in sync (see the location history tables of the terminals B and C in FIG. 8).

Subsequently, location information on the terminal A sequentially changes (Operations 401 to 403), whereby those pieces of location information are notified to a management node (MME or the like) in the mobile network (Operations 404 to 406), and the notified information (cell ID/TID location) is notified to the terminal-location information sync detection section 160 as it is or in a processed form (Operations 407 to 409).

The terminal-location sync detection section 160, when detecting that changes in location information of the terminal A and changes in location information of the terminals B and C are in sync as illustrated in FIG. 8 (Operation 410), notifies location synchronization detection information to the proxy service providing server 110 (Operation 411). The terminal session management section 206 of the proxy service providing server 110, when receiving the location synchronization detection information, sets switching control for the session-VM correspondence switching section 203. Thus, when the terminal A makes new access to the service providing server 110 (Operation 412), the session-VM correspondence switching section 203 operates to cause the virtual machine VM-share accommodating the sessions of the terminals B and C to accommodate a session from the terminal A (Operation 413).

As described above, when locations of a plurality of terminals are synchronously changing, the management of their sessions is combined to be performed by a single virtual machine VM-share in the proxy service providing server 110. Thus, even if accommodating sessions of a plurality of terminals, the physical resource capacity required of the proxy service providing server 110 can be reduced, and the number of VMs migrated between proxy service providing servers is decreased, allowing the load on the network to be lessened. Accordingly, it is possible to increase the usage rate of network resources and server resources to provide services to terminals in the mobile network, and to enhance the quality of service provided to the terminals.

### 5. OTHERS

The proxy service providing server and terminal-location sync detection section according to the above-described exemplary embodiment and example can be implemented by using software, a computer (program-controlled processor such as CPU) for running it, and a storage device.

### INDUSTRIAL APPLICABILITY

The present invention is applicable to techniques of implementing the continuity of a service at the time of anchor relocation in future mobile communication systems.

### REFERENCE SIGNS LIST

100 Virtual machine
101 Virtual machine management section
102 Terminal
103 Service providing server
104 Terminal location change synchronization detection function
110 Proxy service providing server
120 Packet gateway
130 Radio base station
140 Terminal
150 Mobile core node
160 Terminal-location sync detection section

1. A mobile communication system including a plurality of mobile terminals, comprising:
first and second communication apparatuses, each of which is configured to operate virtual machines that accommodate sessions of mobile terminals and a virtual machine controller that controls the virtual machines; and
a terminal location synchronization detector that detects that the first communication apparatus accommodates at least two mobile terminals synchronously changing in location,
wherein responsive to detecting that the at least two mobile terminals are synchronously changing in location, respective sessions of the at least two mobile terminals are accommodated by a single virtual machine in the first communication apparatus.

2. The mobile communication system according to claim 1, wherein the respective sessions of the at least two mobile terminals accommodated by the single virtual machine on the first communication apparatus are relocated to the second communication apparatus by migration of the single virtual machine.

3. The mobile communication system according to claim 1, wherein each of the first and second communication apparatus is a proxy server that relays provision of a service from a service providing server to the mobile terminals, wherein moves of the at least two mobile terminals cause migration of the single virtual machine from the first communication apparatus to the second communication apparatus.

4. A communication apparatus in a mobile communication system including a plurality of mobile terminals, comprising:
a plurality of virtual machines each of which is configured to accommodate sessions of mobile terminals to manage the sessions;
a virtual machine controller that controls the plurality of virtual machines; and
a terminal location synchronization detector that detects that at least two mobile terminals synchronously changes in location,
wherein responsive to detecting that the at least two terminals are synchronously changing in location, the virtual machine controller controls such that respective sessions of the at least two mobile terminals are accommodated by a single virtual machine.

5. The communication apparatus according to claim 4, wherein the respective sessions of the at least two mobile terminals accommodated by the single virtual machine are relocated to another communication apparatus by migration of the single virtual machine.

6. The communication apparatus according to claim 4, wherein the single virtual machine has a proxy server function of relaying provision of a service from a service providing server to the mobile terminals, wherein the virtual machine controller performs migration of the single virtual machine to another communication apparatus, following moves of the at least two mobile terminals.

7. (canceled)

8. (canceled)

9. (canceled)

10. (canceled)

11. A method for controlling sessions of mobile terminals in a communication apparatus in a mobile communication system including a plurality of mobile terminals, comprising:
operating a plurality of virtual machines each of which is configured to accommodate sessions of mobile terminals to manage the sessions;
when at least two terminals are synchronously changing in location, accommodating respective sessions of the at least two mobile terminals in a single virtual machine.

12. The method according to claim 11, further comprising:
relocating the respective sessions of the at least two mobile terminals accommodated by the single virtual machine to another communication apparatus by migration of the single virtual machine.

13. The method according to claim 11, wherein the at least two terminals are synchronously changing in location are detected by using location information of each of the plurality of mobile terminals to compare a moving pattern of a mobile terminal to that of another mobile terminal.

14. The method according to claim 11, wherein the communication apparatus detects that the at least two terminals are synchronously changing in location.

15. The method according to claim 11, wherein the communication apparatus is notified, by a terminal management entity on the mobile communication system, that the at least two terminals are synchronously changing in location.

16. The mobile communication system according to claim 1, wherein the terminal location synchronization detector uses location information of each of the plurality of mobile terminals to detect the at least two mobile terminals synchronously changing in location, by comparing a moving pattern of a mobile terminal to that of another mobile terminal.

17. The communication apparatus according to claim 4, wherein the terminal location synchronization detector uses location information of each of the plurality of mobile terminals to detect the at least two mobile terminals synchronously changing in location, by comparing a moving pattern of a mobile terminal to that of another mobile terminal.
